(19) United States
(12) Patent Application Publication
(10) Pub. No.: US 2008/0218622 A1
(43) Pub. Date: Sep. 11, 2008

(54) Image Pickup Camera

(75) Inventor: Junichi Shinohara, Kanagawa (JP)

Correspondence Address: OBLON, SPIVAK, MCCLELLAND MAIER & NEUSTADT, P.C., 1940 DUKE STREET, ALEXANDRIA, VA, 22314, US

(73) Assignee: RICOH COMPANY, LTD., Tokyo (JP)

(21) Appl. No.: 11/579,817

(22) PCT Filed: Apr. 27, 2005
(86) PCT No.: PCT/JP2005/008447

§ 371 Date: Nov. 9, 2007

(30) Foreign Application Priority Data
May 7, 2004 (JP) 2004-138005

(51) Int. Cl. H04N 5/232

(52) U.S. Cl. 348/345; 348/E05.042

(57) ABSTRACT

An image pickup apparatus includes a photographing optical system; a photographing preparation manipulation judgment device; a photographing implementing manipulation judgment device; a timer adapted for counting a time period from outputting of a signal from the photographing preparation manipulation judgment device to outputting of the signal from the photographing implementing manipulation judgment device; a focus driving device for changing a focused state of an object by changing a positional relation of the lens relative to an image pickup face; an auto focusing (AF) data detector for detecting AF data representative of a distance face up to the object or the focused state of the object; a time-series AF data collector for driving the AF data detector at an interval of a present time period and obtaining the AF data in a chronological manner; and an object movement presumption calculator for presuming changes in distance of the object from the time-series AF data calculating focus moving amount. When the time counted by the timer is not larger than the preset time period, auto focusing operation is implemented based on the focus moving amount calculated by the object movement presumption calculator.

### TECHNICAL FIELD

### Background Art

The present invention relates to an improvement on an image pickup apparatus using an auto focusing method for digital cameras, for example, and especially for use in selectively employing an object movement presumption auto focusing method or a focus locking method. The invention can be applied to auto focusing analog cameras and video cameras.

Heretofore, cameras (image pickup apparatuses) having the auto focusing function have been known. In such auto focus cameras, a time difference (so-called release time lag) from a point of time when a shutter button is entirely pushed to a point of time when photographing is actually carried out may pose a problem. Since a focus position changes relative to an object to be photographed during this release time lag when the object moves, a phenomenon occurs that an image of the object obtained lacks sharpness.

In order to solve this problem, there have been various cameras of an object movement presumption auto focusing (AF) system. See the following Patent documents 1 to 3.

1. JP-A 2001-004909

2. JP-A 07-043603

3. JP-A 2000-231055

In the camera of the object movement presumption AF system, as shown in FIG. 1(A) to FIG. 1(C), when an object 1 to be photographed is approaching a camera, distances from the camera to the object are measured in a chronological order, a focus position after the release time lag is presumed, a lens is driven to meet the focus position in advance so that an optimum focusing may be attained at a point of time of actual exposure.

In FIG. 1, symbols H1 and H2 denote a distance-measuring area and a photographing area, respectively.

On the other hand, the object movement presumption auto focusing may be not favored depending upon photographing techniques. For example, consider a photographing case under focus locking: as shown in FIGS. 2(A) to 2(C), a shutter button is half pressed to adjust a focused state of the object and photographing is carried out after a construction (field angle) is changed, while the adjusted focused state is being maintained. In this case, if the object movement presumption AF is carried out in operation from the half pressing to the full pressing of the release button, not the object 1 which a photographer intends to photograph but a background is focused. Thus, photographing is carried out contrary to the photographer's intention.

Under the circumstances, according to the prior art techniques disclosed in Patent documents 1 to 3, an object movement presumption AF mode is specially provided, so that the photographer may set whether the object movement presumption AF mode is to be carried out or not.

However, it is troublesome for the photographer to set the object movement presumption mode. Further, if the photographer forgets to release the setting of that mode, AF operation is performed different from the photographer's intention.

In view of the above, techniques have been proposed, which automatically discriminate whether the object movement presumption AF should be performed or not. See the following Patent documents 4 to 8.

4. JP-B 05-041966

5. JP-B 08-007322

6. JP-C 02762513

7. JP-C 03002293

8. JP-A 2000-066086

Patent document 4 discloses a construction in which whether the object movement presumption AF is automatically to be performed or not is discriminated based on the number of times of driving the lens. Patent document 5 discloses a construction whether the object movement presumption AF is to be automatically performed or not is discriminated based on signal levels and signal level differences. Patent document 6 discloses a construction in which whether the object movement presumption AF is to be automatically performed or not is discriminated based on change rate and change amount of data on movement. Patent document 7 discloses a construction in which whether the object movement presumption AF is to be automatically performed or not is discriminated based on the rate of the object to be photographed with respect to the entire image. Patent document 8 discloses a construction in which the focus locking is released to perform the object movement presumption AF, based on discrimination of whether the object is moving or not.

### DISCLOSURE OF THE INVENTION

### Problems to be Solved by the Invention

However, according to the conventional techniques to discriminate whether the object movement presumption AF is to be automatically carried out or not, it is difficult to discriminate photographer's intention or slight movement of the object depending upon the level of the signals, the size of the object, etc., so that erroneous judgment may frequently occur.

### Countermeasures to Solve the Problems

The present invention has been accomplished in view of the above-mentioned circumstances, and is aimed at providing an image pickup apparatus which can minimize erroneous judgments in automatic discrimination by a simple discriminating technique and can make photographing more closely to his or her intention through rapidly automatically discriminating as to whether photographing is to be based on the object movement presumption auto focusing (object movement presumption AF) or the focus locking.

The image pickup apparatus according to the present invention comprises:

a photographing optical system adapted for photographing an object to be photographed;

a photographing preparation manipulation judgment device adapted for outputting a signal to order judgment as to whether a photographing preparation motion is started with a manipulation;

a photographing implementing manipulation judgment device adapted for outputting a signal to order judgment whether photographing implementing operation is started with manipulation or not;

a timer adapted for counting a time period from a point of time when the signal is outputted from the photographing preparation manipulation judgment device to a point of time when the signal is outputted from the photographing implementing manipulation judgment device;

a focus driving device adapted for changing a focused state of the object to be photographed by changing a positional relation of the lens relative to an image pickup face;

an auto focusing (AF) data detector adapted for detecting AF data representative of a distance up to the object or the focused state of the object;

a time-series AF data collector adapted for driving the AF data detector at an interval of a preset time period and obtaining the AF data in a chronological manner; and

an object movement presumption calculator adapted for presuming changes in distance of the object from the time-series AF data and calculating focus moving amount;

wherein when the time counted by the timer is not larger than a specified time period, auto focusing operation is implemented based on the focus moving amount calculated by the object movement presumption calculator.

According to the image pickup apparatus of the present invention, erroneous judgments in automatic discrimination can be reduced to the utmost by a simple discriminating technique, and photographing can be implemented more closely to the photographer's intention through rapidly automatically discriminating as to whether photographing is based on the object movement presumption AF (object movement presumption auto focusing) or the focus locking.

The following are preferred embodiments of the image pickup apparatus according to the present invention. Any combination of them are considered also to be preferred embodiments, so long as they are not contradictory to the present invention.

(1) The image pickup apparatus further comprises a focus calculator adapted for calculating a focus moving amount based on a single AF data, wherein when the time period counted by the timer is longer than the preset one, the auto focusing operation is implemented based on the focus moving amount calculated by the focus calculator.

According to this embodiment, the focus locking operation can be implemented in compliance with the photographer's intention.

(2) The image pickup apparatus further comprises a focus calculator adapted for calculating a focus moving amount based on a single AF data, wherein when the photographing preparation manipulation device is manipulated, the focus driving device is once driven based on a focus-driving amount obtained by the object movement presumption calculator, and when the time period counted by the timer exceeds the preset one, the auto focusing operation is implemented while the focusing is changed to the focus moving amount calculated by the focus calculator.

According to the embodiment (2), the time lag in implementing the body movement presumption AF can be reduced.

(3) The time-series AF data collector is operated in an actuated manner regardless of whether the photographing preparation manipulation device or the photographing implementing manipulation device is operated or not.

According to the embodiment (3), since the distance needs not be measured after the release button is manipulated, the time period of the processing after the manipulation of the release button can be shortened.

(4) The image pickup apparatus further comprises an image pickup device adapted for picking up an image of the object to be photographed and converting the image into electric information, and a CCDAF controller adapted for driving the focus driving device by using contrast information of the image obtained by the image pickup device, wherein when the auto focusing operation is to be carried out based on the focus moving amount calculated by the focus calculator, a final focus stopping position is determined by performing a CCDAF control with the CCDAF controller in an area around the focus moving amount.

According to the embodiment (4), since high-speed AF containing implantation of the object movement presumption AF and high-accuracy AF can be selectively used, photographing can be carried out more closely to the photographer's intention.

### BRIEF DESCRIPTION OF THE DRAWINGS

For a better understanding of the invention, reference is made to the attached drawings:

FIGS. 1(A) to 1(C) are figures illustrating a case where photographing is carried out based on an object movement presumption AF method, FIG. 1(A) showing a state that the object to be photographed is present in a remotest position, FIG. 1(B) showing a state that the object is present at an intermediate position nearer to a camera, and FIG. 1(C) showing a state that the object is present at a position nearest to the camera.

FIGS. 2(A) to FIG. 2(C) are figures illustrating a case where photographing is effected based on a focus locking method, FIG. 2(A) showing a desired composition, FIG. 2(B) showing a case where the distance is measured up to an object to be photographed, and FIG. 2(c) showing state in which photographing is carried out after the desired composition is restored in the state the object is being focused.

FIG. 3 is a block diagram of a camera as an image pickup apparatus according to the present invention.

FIGS. 4-1 and 4-2 show a flow chart illustrating the function of Embodiment 1 of the image pickup apparatus according to the present invention.

FIGS. 5-1 and 5-2 show a flow chart illustrating the function of Embodiment 2 of the image pickup apparatus according to the present invention.

### BEST MODES FOR CARRYING OUT THE INVENTION

Best modes of the image pickup apparatus according to the present invention having the object movement presumption AF function will be explained with reference to the attached drawing. These embodiments are merely illustrative of the present invention, and are never intended to limit the scope of the present invention.

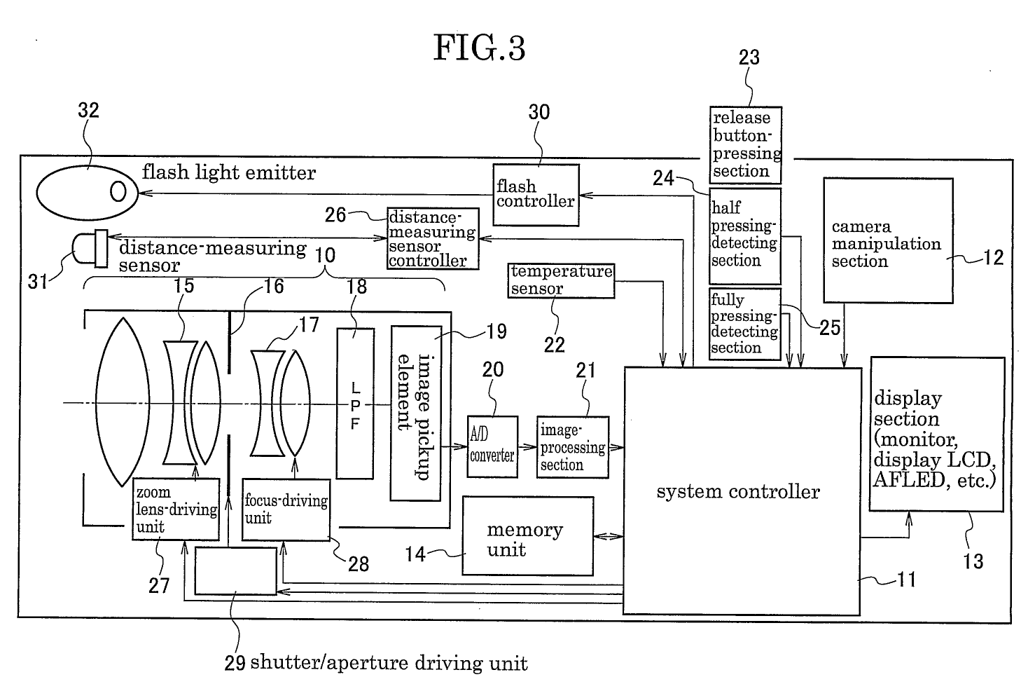

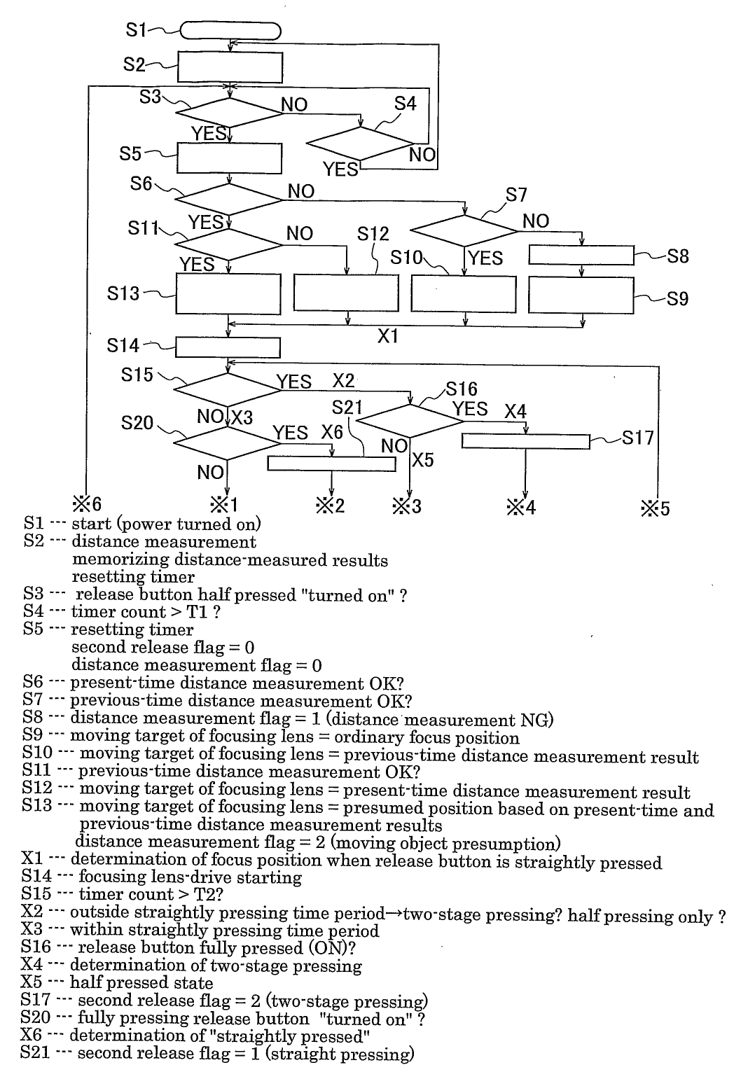

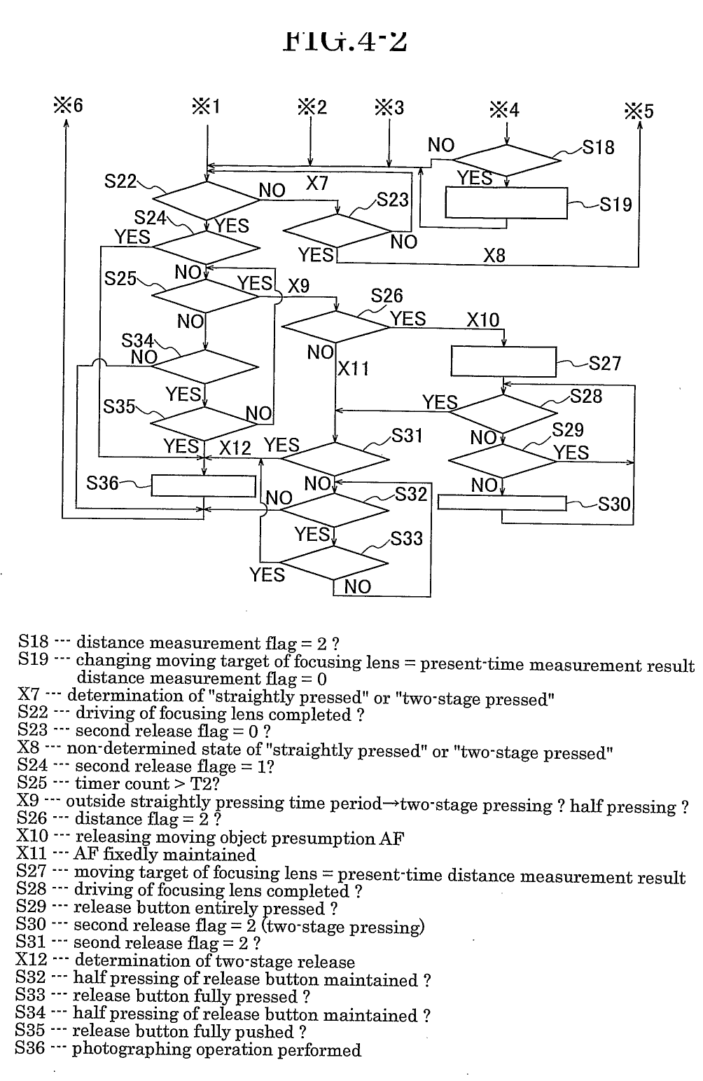

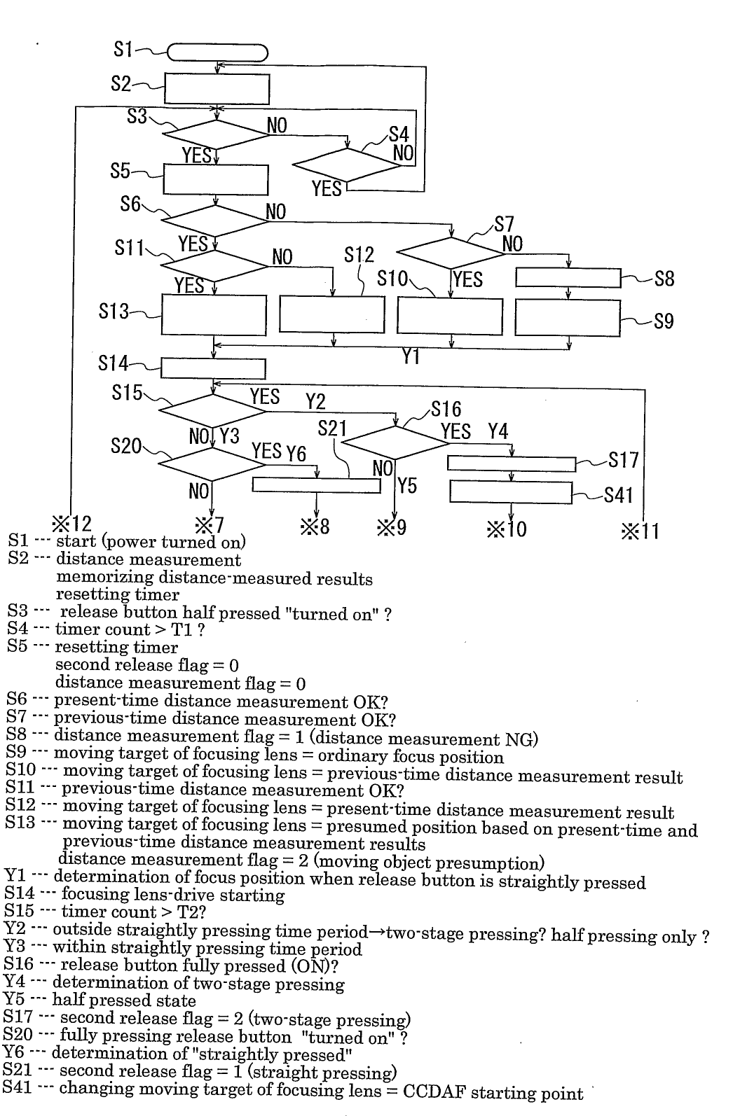

FIG. 3 is a block diagram of a camera as the image pickup apparatus according to the present invention. In FIG. 3, reference numerals 10 and 11 denote a lens barrel unit and a system controller, respectively, and reference numerals 12, 13 and 14 denote a camera manipulating unit, a display unit and a memory unit, respectively.

The lens barrel unit 10 comprises an object-photographing optical unit and an image pickup element (CCD as image pickup device) 19. The object-photographing optical unit comprises a zoom lens unit 15, a shutter/aperture 16, a focusing lens unit 17 and a low pass filter 18.

The system controller 11 receives electric information from the image pickup element 19 via an A/D filter 20 and an image processing section 21, and also receives temperature detection signals from a temperature sensor 22 and manipulation signals from the camera manipulating unit 12.

The system controller 11 also receives half press detection signals (first release signals) from a half press-detecting unit 24 constituting a part of a release button pressing section 23 and full press detection signals (second release signals) from a full press-detecting unit 25.

The system controller 11 outputs control signals to a distance-measuring sensor controller 26 constituting a part of an AF data detector, a zoom lens-driving unit 27, a focusing lens-driving unit 28, a shutter/aperture-driving unit 29 and a flash controller 30, and controls them. The focus-driving unit 28 constitutes a part of the focus-driving unit which changes a positional relation of the lens relative to an image pickup face and thereby changes a focused state of the object to be photographed.

The distance-measuring sensor unit 26 controls a distance-measuring sensor 31 as an external AF sensor, which measures the distance up to the object 1 to be photographed. Measured distance information is inputted into the system controller 11 via the distance-measuring sensor controller 26. The flash controller 30 makes flash light-emitting section 32 emit light according to instruction from the system controller 11.

The display unit 13 comprises a monitor, a display LCD, and AFLED (auto focusing LED). These elements are controlled to perform lighting, lighting out, displaying, etc. according to command signals from the system controller 11.

The system controller 11 exchanges information between the memory unit 14 according to necessity of the above processings.

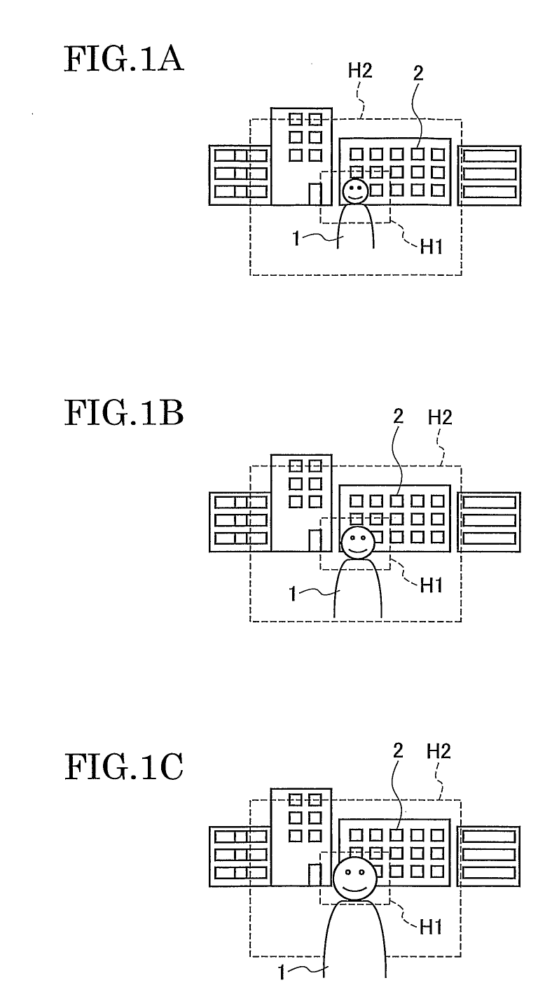

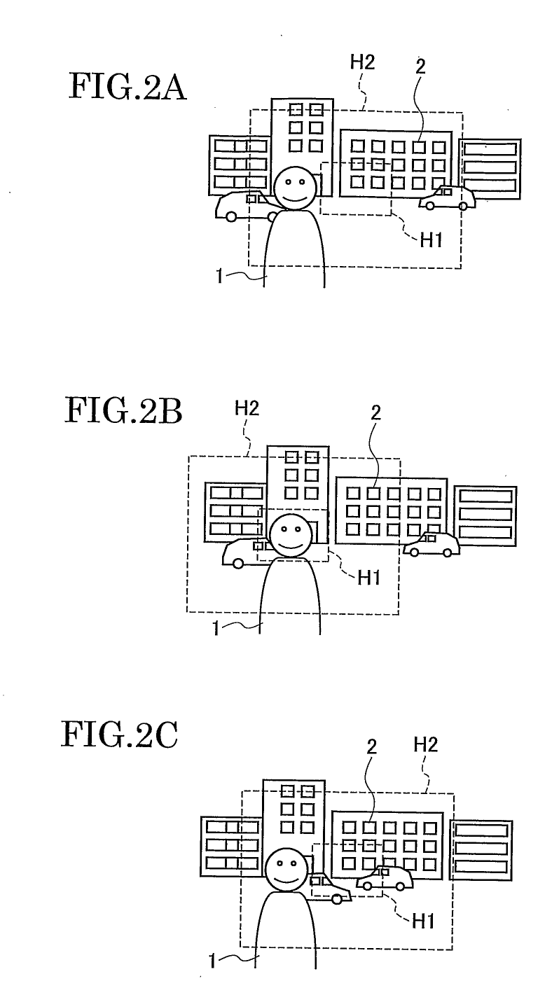

Their constructions are the same as those in commercially available digital cameras, and therefore the constructions and the functions are the same as publicly known. Thus, their explanation is omitted. Portions regarding the core of the present invention will be explained by using a flow chart in FIGS. 4-1 and 4-2.

The essential technical idea of the present invention lies in that on the basis of the length of a time period from a time when the release button is half pressed to a time when the release button is fully pressed, it is judged whether an object movement presumption AF is to be implemented or a focus locking mode is implemented.

If the object 1 which the photographer intends to photograph is a moving object, only a moment is principally available for shutter chance. Thus, it is considered that the time period from the point of time when the release button is half pressed (first releasing) to the point of time when the release button is fully pressed (second releasing) is short, and the photographer presses the release button at once without consciousness of half pressing.

To the contrary, when the photographer intends the focus locking mode, two-stage operations consisting of focusing with the half pressing and photographing with the full pressing. It is extremely rare that the releasing operation is done fluently from the half pressing to the full pressing. It is considered that the time period from the point of time when the release button is half pressed to the point of time when the release button is fully pressed is long, and the photographer does not intend to implement the object movement presumption AF in the case of the two-stage pressing.

In the following, a first embodiment of the image pickup apparatus according to the present invention will be explained with reference to the flow chart shown in FIGS. 4-1 and 4-2.

The system controller 11 comprises a timer, a body movement presumption calculator and a focus calculator therein. The moving object presumption calculator is adapted to presume of changes in distances of an object to be photographed from time-series auto focus (AF) data and calculating a focus-moving amount. The focus calculator is adapted to calculate a focus-moving amount based on a single AF datum.

First, the image pickup apparatus is turned on to be in a storing state (S. 1). Then, distances are measured each at a specified time interval of T1 by controlling with a controller 11. Distances are measured continuously with a distance-measuring sensor 31 in a monitoring state, and measured results are stored. The timer is reset immediately after starting (S2). Focusing may be carried out, but only the distance-measuring action is preferably carried out in considering the consumption of the cell.

Then, whether a release bottom is half pressed (ON) or not is judged (S. 3). When the shutter (release bottom) is not half pressed, the process proceeds to S. 4 where it is judged whether a timer count is greater than T1 or not. If the timer count is greater than T1 (“yes”), the process proceeds to S. 2 to repeat the processings in S. 1 to S.4. That is, distances are continuously measured repeatedly at an interval of the preset time period T1. If the timer count is not longer than the preset time period T1 (“no), the processings in S3 and S4 are repeated.

That is, the system controller 11 functions as a time-series AF data-acquiring unit for acquiring the time-series AF data irrespective of image pickup operations.

When the release bottom is half pressed, the system controller 11 resets the timer, sets a second release flag at “0”, and also sets a distance measuring flag at “0” (S. 5). The time starts to count the time immediately after the time is reset.

Then, it is judged whether a present-time distance measurement is OK or not (S. 6). If the answer in S. 6 is “no”, it is judged whether a previous-time distance measurement is OK or not (S. 7). If an answer in S. 7 is “no”, a distance measurement flag is set at “1” because the measurement could not be done (S. 8). Thereafter, a focusing lens-moving target value is set at an ordinary focus position (S. 9). Then, the process proceeds to a (S. 14). If an answer is “yes” in S. 7, a focusing lens movement target value is set at the previous-time distance measurement result (S. 10). Then, the process proceeds to S. 14.

In S. 6, if the present-time distance measurement is OK, the process proceeds to S. 11 where it is judged whether the previous-time distance measurement is OK or not. If an answer in S. 11 is “no”, a focusing lens movement target value is set at a present-time distance measurement result (S. 12). Then, the process proceeds to S. 14. If an answer in S. 11 is “yes”, the focus lens movement target is a presumed position of the moving object obtained from the present-time and previous-time distance measurement results. The distance measurement flag is set at “2” (S. 13), and the process proceeds to S. 14.

Herein, the distance measurement flag “0 means that the distance measurement is OK. The distance measurement flag “1” means that neither the previous-time distance measurement result nor the present-time measurement result are not obtained. The previous-time distance measurement result is one obtained just before that obtained in the present-time distance measurement. Processings in S. 6 to S. 13 determines a movement target position in focusing operation.

That is, if neither the previous-time distance measurement result nor the present-time distance measurement result are obtained, the movement target value for the focusing lens group 17 is set at the preset ordinary focus position. If the present-time distance measurement result is obtained but the previous-time is not obtained, the movement target value of the auto focusing of the focusing lens group 17 is set at the present time If both the previous-time distance measurement result and the present-time distance measurement result are obtained, the target movement value for the focusing lens group 17 is set at the moving object presumed position.

The processings in S. 2 to S. 13 determine the focus position including the object movement presumption AF position. Therefore, a half press detector 24 functions as a photographing preparation manipulation judgment means to output a signal for commanding judgment as to whether a photographing preparation operation is started or not by manipulation.

Next, the auto focusing lens unit 17 is started to operate under control with the system controller 11 (S. 14). Then, a timer watches a time period T2 from a point of time when the release bottom is half pressed to a point of time when the release bottom is fully pressed. That is, it is judged whether the timer count is longer than a preset T2 or not (S. 15). If an answer in S. 15 is “yes”, it is judged whether the release button is fully pushed or not (S. 16). If an answer in S. 16 is “yes”, it is judged whether the distance measurement flag is “2” or not (S. 18) after a second release flag (two-stage pressing flag) is set at “2” (S. 17). If an answer in S. 18 is “yes”, the target movement value of the focusing lens is changed to the present-time distance measurement result. After the distance measurement flag is set at “0” (S. 19), the process proceeds to S. 22.

That is, if the time period from the point of time when the release button is half pressed to the point of time when the release button is fully pressed is longer than the preset time period T2, it is judged that a photographer intends to take a photographing through focus locking. Thus, the full pressing of the release button is fixed by setting the second release flag at “2” after the release button is fully pressed. The second release flag “0” means that it is not fixed whether the photographing is effected through the object movement presumption calculation or through focus locking. The second release flag “1” means that the photographing is effected through the object movement presumption calculation. Further, the second release flag “2” means that the photographing is fixed through focus locking.

This is done to assuredly proceed the process into a sequence exclusively for the two-stage processing, since the time period may exceed the preset time T2 during the movement of the focus depending upon the focus-moving amount. As to general lens barrels for commercially available cameras, it is considered reasonable that the focusing time period is around 0.3 second, whereas the preset time period T2 is reasonably around 0.5 to around 1 second sensuously due to the operation of the photographer. Processings in S. 16 to S. 18 are necessary in case that a long-focusing lens having a wide focusing area is used or in a case that a minimum photographing distance is short. Although these processings are preferably done even in the ordinary cameras, such processings may be an omittable processing flow.

Then, it is judged whether the distance measurement flag is “2” or not. If the distance measurement flag is “2”, the distance measurement flag is set at “0” that means that the distance measurement is OK, and the target movement value of the focusing lens is set to the present-time distance measurement result. Thereby, focusing movement is carried out based on the distance measurement result measured at the time when the release button is half pushed. The distance measurement flag “2” means release from the body movement presumption calculation.

If an answer in S. 16 is “no”, it is judged that the release button is half pressed. Then, the process proceeds to S. 22.

If an answer in S. 15 is “no”, it is judged in S. 20 whether the release button is fully pressed or not. If an answer is “yes”, the process proceeds to S. 22 after the second release flag is set at “1” (S. 21). This ensures that the release button is pressed from the half pressing to the full pressing in a time shorter than the preset time period T2. That is, it is determined that the release button is pressed at once (one-time pressing) without having consciousness of the half pressing of the release button.

If an answer in S. 20 is “no”, the process proceeds to S. 22 through the judgment that the release button is half pressed.

In S. 22, it is judged whether the focusing lens is completely driven or not. If an answer in S. 22 is “no”, it is judged whether the second release flag is “0” or not (S. 23). If an answer in S. 23 is “no”, the processing in S. 22 is continued. That is, the focus-moving operation under focus locking or focus-moving operation through object movement presumption auto focusing is continued.

If an answer in S. 23 is “yes”, the process goes back to S. 15, so that the processings in S. 15 to S. 22 are repeated. This is to waiting for determination as to whether photographing is aimed at focus locking with full pressing of the release button or at the object movement presumption AF.

If an answer in S. 22 is “yes”, it is judged whether the second release flag is “1” or not (S. 24). If an answer in S. 24 is “yes”, the process jumps to S. 36 in which photographing is immediately effected. Thereby, photographing is immediately carried out based on the object movement presumption AF. Then, the process goes back to S3, and the proceedings in S. 3 and thereafter are repeated.

If an answer in S. 24 is “no”, it is judged whether the timer count is longer than T2 or not (S. 25). If an answer in S. 25 is “yes”, it is judged whether the distance measurement flag is “2” or not (S. 26). If an answer in S. 26 is “yes”, the process proceeds to S. 27 to release the focusing motion based on the object movement presumption AF. In S. 27, the target movement value of the focus lens is set to the present-time distance measurement result. Thereafter, it is judged whether the driving motion of the focusing lens is completed or not (S. 28). If an answer in S. 28 is “yes”, the process jumps to S.31.

If an answer in S. 28 is “no”, it is judged whether the release button is fully pressed or not (S. 29). If an answer in S. 29 is “yes”, the processings in S. 28 and S. 29 are continued until the focusing motion of the focusing lens is continued. If an answer in S. 29 is “no”, the processings in S. 28 to S. 30 are continued until the focusing motion is completed after the second release flag is set at “2” (S. 30). Thereby, it is determined that the release button is fully pressed for the purpose of focus locking.

In S. 31, it is judged whether the second release flag is “2” or not. If an answer in S. 31 is “yes”, the process jumps to S. 36 where photographing is immediately carried out under focus locking.

If an answer in S. 31 is “no”, the process proceeds to S. 32 where it is judged whether the release button is half pressed or not (S. 32). If an answer in S. 32 is “no”, the process is returned to the S. 3, without carrying the photographing, so that the S3 and the succeeding processings are repeated.

If an answer in S. 32 is “yes”, it is judged whether the release button is fully pressed or not (S. 33). If an answer in S. 33 is “yes”, the process proceeds to S. 36 where photographing is carried out under the auto focusing under focus locking. Then, the process is returned to S. 3. If an answer in S. 33 is “no”, the process is returned to S. 32 where it is watched whether the release button is half pressed or not. If an answer in S. 32 is “no”, the process is returned to the S. 3, without carrying the photographing, so that the S3 and the succeeding processings are repeated.

Therefore, the full pressing-detecting section 25 functions as a photographing implementing manipulation judgment device (photographing implementing manipulation judgment means) for outputting a signal enabling judgment on starting of implementing the photographing with manipulation. The timer functions as a timer to count a time period from a point of time when a signal is outputted from a photographing preparation manipulation judgment device (photographing preparation manipulation judgment means) to a point of time when a signal is outputted from the photographing implementing manipulation judgment device.

Embodiment 1 has the construction that focus is moved based on the body movement presumption auto focusing mode and the object movement presumption mode is released at the stage of fully pressing the release button. Thus, during the previous stage until the release button is fully pressed, the focusing lens is driven in advance based on the object movement presumption auto focusing mode, so that the release time lag based on the body movement presumption auto focusing mode can be minimized.

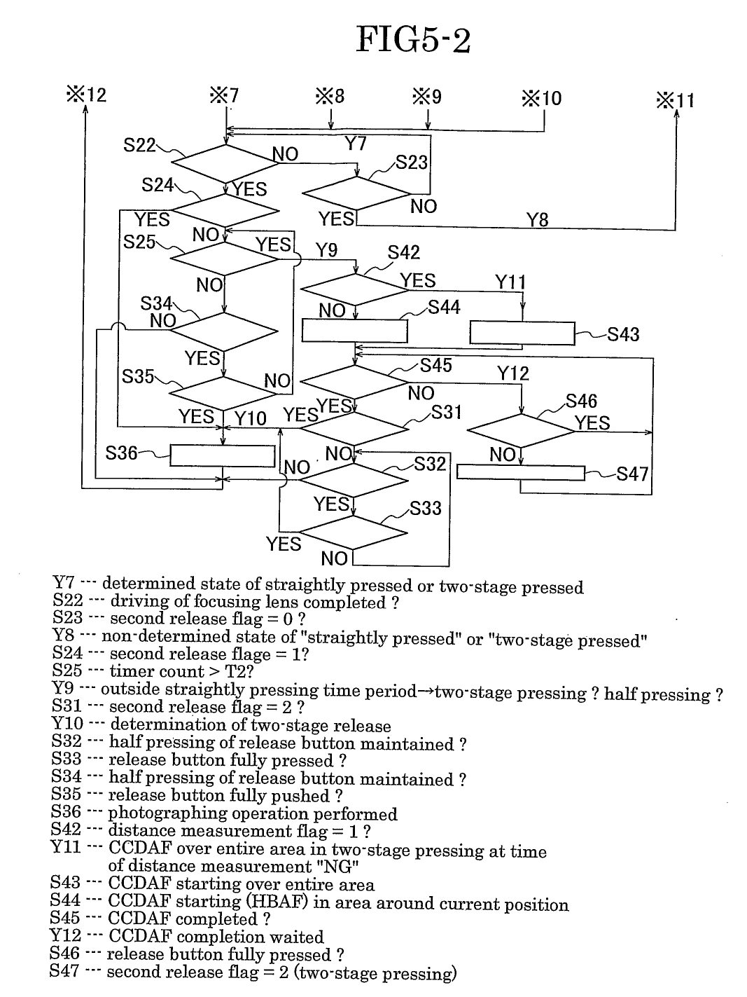

FIGS. 5-1 and 5-2 show a flow chart of Embodiment 2 according to the present invention.

The embodiment in FIGS. 5-1 and 5-2 will be explained only at portions different from those in FIGS. 4-1 and 4-2, while steps for carrying out the same processings as in FIGS. 4-1 and 4-2 are denoted by the same step numbers as in FIGS. 4-1 and 4-2.

The processings in S. 1 to S. 15 of Embodiment 2 are the same as in Embodiment 1. If it is judged in S. 16 that the release button is pressed, the process proceeds to S. 17 where the second release flag is set at “2”, and the target movement value of the focusing lens is set at the starting point of CCDAF (S. 41). Thereafter, processings in Steps S. 22 to S. 25 are carried out.

The CCDAF is an AF distance measuring system for finding out the focus position based on contrast evaluating values of image data. For, the distance measurement precision of the external AF sensor is generally less insufficient that that required by the digital camera.

Next, processings in S. 22 to S. 24 are carried out as in Embodiment 1, and it is judged in S. 25 whether the timer count is longer than T2 or not. If the timer count is judged to be not longer than T2, photographing is carried out similarly with Embodiment 1.

If the timer count is judged to be longer than T2 in S. 25, it is judged whether the distance measurement flag is “1” or not (S. 42). If an answer in S. 42 is “yes”, the CDAF processing is started over the entire area (S. 43). If an answer in S. 42 is “no”, the CCDAF (HBAF) processing around a current position is started (S. 44).

Next, the system controller 11 judges whether the CCDAF is completed or not (S. 45). If an answer in S. 45 is “no”, the process proceeds to S. 46 where it is judged whether the release button is fully pressed or not. If an answer in S. 46 is “yes”, the process is returned to S. 45. Then, the processings in S. 45 and S. 46 are repeated, and waited until the CCDAF processing is completed.

If an answer in S. 46 is “no”, the process is returned to S. 45 after the second release flag is set to “2” (S. 47). Then, the processings in S. 45 to S. 47 are repeated until the CCDAF processing is completed. If an answer in S. 45 is “yes”, the process proceeds to S. 31, and the processings in S. 31 and the succeeding steps are carried out similarly to Embodiment 1.

In this Embodiment 2, since the focusing speed in the focusing motion under the object movement presumption AF is preferential to the distance measurement accuracy in the case of focusing in the object movement presumption AF mode, the focus-moving speed realized based on the distance measurement with the external AF sensor only, and the distance is measured by the HBAF or the entire CCDAF after the release button is entirely pushed.

Thereby, the photographer can freely select the high-speed AF motion including the object movement presumption or the high-accuracy AF mode with the HABAF (CCDAF), so that the photographing can be made according to his or her intention.

As mentioned above, the image pickup apparatus has been explained as constituted to drive a part of the lenses of the photographing optical system. The present invention is not limited to this. For example, the entire photographing optical system may be moved relative to the CCD as the image pickup element 10. Alternatively, it may be that the image pickup optical system is fixed, while the image pickup element 10 is moved.

### INDUSTRIAL APPLICABILITY

The present invention, which relates to an improvement on an image pickup apparatus using an auto focusing method for digital cameras, for example, and especially for use in selectively employing an object movement presumption auto focusing method or a focus locking method, can be applied to auto focusing analog cameras and video cameras.

1. An image pickup apparatus comprising:
a photographing optical system adapted for photographing an object to be photographed;
a photographing preparation manipulation judgment device adapted for outputting a signal to order judgment as to whether a photographing preparation motion is started with a manipulation;
a photographing implementing manipulation judgment device adapted for outputting a signal to order judgment whether photographing implementing operation is started with manipulation or not;
a timer adapted for counting a time period from a point of time when the signal is outputted from the photographing preparation manipulation judgment device to a point of time when the signal is outputted from the photographing implementing manipulation judgment device;
a focus driving device adapted for changing a focused state of the object to be photographed by changing a positional relation of the lens relative to an image pickup face;
an auto focusing (AF) data detector adapted for detecting AF data representative of a distance face up to the object or the focused state of the object;
a time-series AF data collector adapted for driving the AF data detector at an interval of a preset time period and obtaining the AF data in a chronological manner; and
an object movement presumption calculator adapted for presuming changes in distance of the object from the time-series AF data and calculating focus moving amount;
wherein when the time counted by the timer is not larger than a specified time period, auto focusing operation is implemented based on the focus moving amount calculated by the object movement presumption calculator.

2. The image pickup apparatus set forth in claim 1, which further comprises a focus calculator adapted for calculating a focus moving amount based on a single AF data and wherein when the time period counted by the timer is longer than the specified one, the auto focusing operation is implemented based on the focus moving amount calculated by the focus calculator.

3. The image pickup apparatus set forth in claim 1, which further comprises a focus calculator adapted for calculating a focus moving amount based on a single AF data and wherein when the photographing preparation manipulation device is manipulated, the focus driving device is once driven based on a focus-driving amount obtained by the object movement presumption calculator, and when the time period counted by the timer exceeds the specified one, the auto focusing operation is implemented while the focusing is changed to the focus moving amount calculated by the focus calculator.

4. The image pickup apparatus set forth in claim 1, wherein the time-series AF data collector is operated in an actuated manner regardless of whether the photographing preparation manipulation device or the photographing implementing manipulation device is operated or not.

5. The image pickup apparatus set forth in claim 2, wherein the time-series AF data collector is operated in an actuated manner regardless of whether the photographing preparation manipulation device or the photographing implementing manipulation device is operated or not.

6. The image pickup apparatus set forth in claim 3, wherein the time-series AF data collector is operated in an actuated manner regardless of whether the photographing preparation manipulation device or the photographing implementing manipulation device is operated or not.

7. The image pickup apparatus set forth in claim 2, which further comprises an image pickup device adapted for picking up an image of the object to be photographed and converting the image into electric information, and a CCDAF controller adapted for driving the focus driving device by using contrast information of the image obtained by image pickup device and wherein when the auto focusing operation is to be carried out based on the focus moving amount calculated by the focus calculator, a final focus stopping position is determined by performing a CCDAF control with the CCDAF controller in an area around the focus moving amount.

8. The image pickup apparatus set forth in claim 3, which further comprises an image pickup device adapted for picking up an image of the object to be photographed and converting the image into electric information, and a CCDAF controller adapted for driving the focus driving device by using contrast information of the image obtained by image pickup device and wherein when the auto focusing operation is to be carried out based on the focus moving amount calculated by the focus calculator, a final focus stopping position is determined by performing a CCDAF control with the CCDAF controller in an area around the focus moving amount.
